(19) United States
(12) Patent Application Publication
(10) Pub. No.: US 2026/0259362 A1
(43) Pub. Date: Sep. 3, 2026

(54) MIXED-REALITY WAVEGUIDE COMBINER WITH REDUCED WORLD-SIDE LEAKAGE

(71) Applicant: Microsoft Technology Licensing, LLC, Redmond, WA (US)

(72) Inventors: Manisha SINGH, Espoo (FI); Mehmet KOC, Kirkkonummi (FI)

(73) Assignee: Microsoft Technology Licensing, LLC, Redmond, CA (US)

(21) Appl. No.: 19/066,903

(22) Filed: Feb. 28, 2025

(51) Int. Cl. F21V 8/00; G02B 27/01

(52) U.S. Cl. CPC G02B 6/0036; G02B 6/0016; G02B 6/0045; G02B 6/0065; G02B 27/0172; G02B 2027/0178

(57) ABSTRACT

A mixed-reality waveguide combiner for use in an optical display system of a head-mounted display (HMD) device for mixed-reality applications in which virtual images are displayed over views of the real world by an HMD device user is disclosed. A gradient refractive index is utilized in a surface relief grating having depth-modulated grating structures along with a thickness-modulated residual layer. A foundation layer, providing a contrasting refractive index to that of the gratings and the residual layer, may be utilized to provide increased resistance against parasitic diffraction away from the HMD device user towards the surrounding world-side environment. Such world-side leakage causes a phenomenon known as “eye glow” which can reduce social comfort by obscuring the user's eyes or undesirably increase HMD device observability.

### BACKGROUND

Mixed-reality computing devices, such as head-mounted display (HMD) devices may be configured to display information to a user about virtual objects and/or real objects in a field of view (FOV). For example, an HMD device may be configured to display, using a see-through display system, virtual environments with real-world objects mixed in, or real-world environments with virtual objects mixed in. Diffractive optical elements (DOEs) comprising surface relief gratings (SRGs) can be utilized with waveguides in the display system to provide entrance pupil replication of virtual images from a display engine and guide the image light to the user's eyes over an enlarged eyebox.

### SUMMARY

Undesirable world-side leakage of light for virtual images is reduced in a mixed-reality HMD device using an output-coupling diffractive optical element (DOE) in a waveguide combiner that is implemented using a surface relief grating (SRG) having a gradient refractive index and thickness-modulated residual layer. A foundation layer having a contrasting refractive index to the SRG and residual layer is additionally or alternatively utilized to reduce world-side light leakage. Reducing world-side light leakage, commonly termed “eye glow,” from the HMD device helps to decrease HMD device observability. Social comfort is also improved because eye glow can obscure the user's eyes which can prevent eye contact and diminish the user's sense of presence in the mixed-reality environment.

The SRG in the output-coupling DOE has grating structures with modulated depth in which shallower gratings have a lower refractive index and deeper gratings have a higher refractive index. In combination with the thickness-modulated residual layer, the lower efficiency of the shallower gratings reduces forward-propagating virtual image light leaking into the real-world environment of the HMD device while simultaneously enabling light to propagate to the deeper gratings to thereby improve output-coupling efficiency and/or virtual image uniformity over the entirety of the eyebox on the eye side of the waveguide combiner. The foundation layer with contrasting refractive index to that of the SRG provides an alternative to the thickness-modulated residual layer while typically being readily fabricated using thin film deposition techniques such as spin coating.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### DESCRIPTION OF THE DRAWINGS

FIG. 1 shows a pictorial partially cutaway view of an illustrative mixed-reality head-mounted display (HMD) device;

FIG. 2 illustratively shows virtual images that are overlayed onto real-world images within a field of view (FOV) of a mixed-reality HMD device;

FIG. 3 shows illustrative components of a display system that may be utilized in a mixed-reality HMD device;

FIG. 4 shows propagation of light in a waveguide by total internal reflection (TIR);

FIG. 5A shows a top view of a periscope configuration of an illustrative waveguide combiner with an exit pupil expander in which the exit pupil is expanded along two directions of an FOV;

FIG. 5B shows a top view of a mirror configuration of an illustrative waveguide combiner with an exit pupil expander in which the exit pupil is expanded along two directions of an FOV;

FIG. 6 shows a front view of an illustrative waveguide combiner with an exit pupil expander in which the exit pupil is expanded along two directions of the FOV via pupil replication;

FIG. 7 shows an illustrative input to an exit pupil expander in which the FOV is described by angles in horizontal, vertical, or diagonal orientations;

FIG. 8 illustratively shows a field propagating in a waveguide combiner being extracted on the real-world side of the combiner that produces a phenomenon referred to as “eye glow”;

FIG. 9 shows a front view of a user with an HMD device in which eye glow causes partial occlusion of the user's eyes, among other issues;

FIG. 10 shows a pictorial front view of an illustrative sealed visor that may be used as a component of an HMD device;

FIG. 11 shows a pictorial rear view of an illustrative sealed visor;

FIG. 12 shows a partially disassembled view of an illustrative sealed visor;

FIG. 13 shows illustrative propagation paths of virtual image light in an arrangement of optical coupling elements in a waveguide combiner;

FIGS. 14A, 14B, and 14C show illustrative configurations for waveguide plates that support propagation of different wavelengths of light as components of an RGB (red, green, blue) color model;

FIG. 15 shows a profile of a portion of an illustrative binary diffraction grating having straight gratings;

FIG. 16 shows an asymmetric profile of a portion of an illustrative slanted diffraction grating having asymmetric gratings;

FIG. 17 is a graph showing curves for a refractive index that varies as a function of grating feature depth and residual layer thickness that varies as a function of grating feature depth;

FIGS. 18A, 18B, 18C, and 18D show illustrative variations of an output-coupling surface relief grating (SRG) that is disposed on a foundation resin layer that has a refractive index that is different from that of the grating features;

FIG. 19 shows an illustrative conventional SRG having low Bragg selectivity such that diffraction occurs on both the eye side and real-world side of a waveguide to thereby cause strong eye glow;

FIG. 20 shows an illustrative SRG, arranged in accordance with the present principles, that has stronger Bragg selectivity to thereby reduce eye glow;

FIG. 21 is a table comparing efficiency and uniformity for display systems using a conventional output-coupling SRG and systems using output-coupling SRG embodiments arranged in accordance with the present principles;

FIG. 22 is an illustrative taxonomy of optical material deposition techniques in accordance with the present principles;

FIG. 23 is an illustrative taxonomy of SRG fabrication techniques in accordance with the present principles;

FIGS. 24, 25, and 26 show illustrative arrangements for inkjet printing equipment used in the fabrication of SRGs;

FIG. 27 shows an illustrative one-dimensional array of resin droplets disposed on a substrate, in which the resin droplets have different and/or mixed refractive indexes in various spatial patterns;

FIGS. 28A, 28B, and 28C show illustrative processes for manufacturing surface relief gratings using a nanoimprint lithography (NIL) technique;

FIG. 29 is a flowchart of an illustrative method for fabricating an SRG having gradient refractive index grating features;

FIG. 30 is a pictorial view of an illustrative example of a virtual-reality or mixed-reality HMD device that is configurable to use the present waveguide combiner with reduced world-side leakage;

FIG. 31 shows a block diagram of an illustrative example of a virtual reality or mixed-reality HMD device that is configurable to use the present waveguide combiner with reduced world-side leakage; and

FIG. 32 shows a block diagram of an illustrative electronic device that incorporates a mixed-reality display system using the present waveguide combiner with reduced world-side leakage.

Like reference numerals indicate like elements in the drawings. Elements are not drawn to scale unless otherwise indicated.

### DETAILED DESCRIPTION

Light for virtual images in mixed-reality applications, in which images of virtual objects are combined with views of the real world, can leak from HMD and other electronic devices that employ waveguide-based combiners having optical couplers. Such light is typically considered wasted because it is not used to display virtual images to a device user and thus an energy cost is imposed which is typically undesirable for battery-powered devices.

Light leaking from the waveguide combiner that propagates in a forward direction towards the real-world side of the device (as opposed to the rearward direction towards the eye side of the device) is often manifested as “eye glow” which raises security concerns in some mixed-reality HMD device use cases in which detectability of device users is sought to be minimized, for example, in military and security environments. Such forward-propagating virtual image light can also overlay a user's eyes when seen by an observer. This phenomenon presents social interaction difficulties between mixed-reality HMD device users and others by limiting eye contact in some use cases.

The present mixed-reality waveguide combiner is constructed with output-coupling diffractive optical elements (DOEs) configured with surface relief grating (SRG) structure to advantageously enable virtual image light to be propagated throughout the output-coupling DOE with high uniformity and/or efficiency across replicated pupils over an enlarged eyebox with substantially reduced real-world side leakage. The brightness of the virtual image display can be increased on the waveguide combiner, in some implementations, without a corresponding increase in electrical power usage.

Reducing forward-propagating virtual image light that leaks from the waveguide combiner lowers device and user detectability, particularly, for example, in low-light scenarios where eye glow can present a security risk. Reduction in the forward-propagating virtual image light also improves social interaction among mixed-reality device users by reducing virtual image overlay with a user's eyes to facilitate eye contact.

In an illustrative embodiment of the present principles, a see-through waveguide combiner in a mixed-reality head mounted display (HMD) device includes three diffractive optical elements (DOEs) disposed on a waveguide substrate. An input-coupling DOE in-couples virtual images from a display engine into the waveguide combiner. An output-coupling DOE out-couples the virtual images to the HMD device user with expanded exit pupil in one direction. And an intermediate redirection DOE optically couples the input-coupling DOE to the output-coupling DOE while expanding the exit pupil of the virtual images in a second direction that is orthogonal to the first.

The input-coupling, redirection, and output-coupling DOEs are implemented using surface relief gratings (SRGs). In the output-coupling DOE, the SRG has grating structures that are depth-modulated with increasing depth along the propagation direction of the virtual images. A residual layer in the SRG between the grating structures and the waveguide substrate has a modulated thickness profile in which the thickness of the residual layer varies by grating depth. As the grating depth varies by location on the output-coupling DOE, it may be appreciated that the thickness of the residual layer is therefore also variable by location.

The refractive index of the grating structures in the output-coupling DOE follows a gradient profile such that the refractive index varies by grating depth and location on the output-coupling DOE. The modulated residual layer depth and gradient refractive index are implementable in different designs. For example, one design optimizes output-coupling efficiency (i.e., the effectiveness of the DOE in guiding virtual image light to the eyes of the HMD device user), while another design optimizes display uniformity (i.e., illumination uniformity or the consistency of brightness across the entirety of the eyebox and field of view (FOV). With both designs for the combination of modulated residual layer depth and gradient refractive index, forward-propagating virtual image light leaking to the real-world side of the waveguide combiner is significantly reduced compared to conventional combiner designs while providing an FOV that meets design goals.

In another illustrative embodiment of the present principles, the SRG in the output-coupling DOE is disposed on a foundation layer. The foundation layer alternatively comprises a single layer of optical resin having a constant refractive index or multiple layers of resin where each layer has a different refractive index. The foundation layer is configured to implement a contrast between the refractive index of the SRG (including the grating structures and residual layer) and that of the foundation layer. For example, the SRG may have a higher refractive index relative to that of the foundation layer, or vice versa. The foundation layer is implementable in different designs to optimize output-coupling efficiency or display uniformity. With both designs for the foundation layer, forward-propagating virtual image light leaking to the real-world side of the waveguide combiner is significantly reduced compared to conventional combiner designs while providing an FOV that meets design goals.

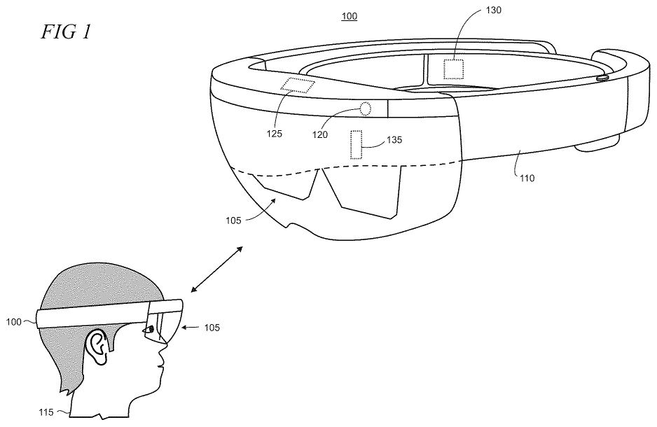

Turning now to the drawings, FIG. 1 shows a pictorial partially cutaway view of an illustrative mixed-reality HMD device 100. In this example, the HMD device includes a display system 105 and a frame 110 that wraps around the head of a user 115 to position the display system near the user's eyes to provide a virtual-reality or mixed-reality experience to the user.

Any suitable technology and configuration may be used to display images using the display system. For example, the display system may be an opaque light-emitting diode (LED) display, a liquid crystal display (LCD), a liquid crystal on silicon (LCoS) display panel, a micro-electromechanical system (MEMS) scanner display system, or any other suitable type of display device or micro-display that operates in transmission, reflection, or emission. In some implementations, outward facing cameras 120 may be provided that capture images of the surrounding physical environment, and these captured images may be rendered on the display system 105 along with computer-generated virtual images that augment the captured images of the physical environment.

For a mixed-reality experience, the display system 105 may be see-through so that the user of the HMD device 100 can view physical, real-world objects in the physical environment over which pixels for virtual objects are overlayed. For example, the display system may include one or more partially transparent waveguides used in conjunction with a virtual image-producing imager or display engine.

The frame 110 may further support additional components of the HMD device 100, including a processor 125, an inertial measurement unit (IMU) 130, and an eye tracker 135. The processor may include logic and associated computer memory configured to receive sensory signals from the IMU and other sensors, to provide display signals to the display system 105, to derive information from collected data, and to enact various control processes described herein.

The display system 105 may be arranged in some implementations as a near-eye display. Near-eye display systems are often used, for example, in HMD devices in industrial, commercial, and consumer applications. Other devices and systems may also use near-eye display systems, as described below. The near-eye display system is an example that is used to provide context and illustrate various features and aspects of the present principles and is not intended to be limiting.

In a near-eye display, the display engine does not actually shine the images on a surface such as a glass lens to create the display for the user. This is not feasible because the human eye cannot focus on something that is that close. Rather than create a visible image on a surface, the near-eye display uses an optical system to form a pupil and the user's eye acts as the last element in the optical chain and converts the light from the pupil into an image on the eye's retina as a virtual display. It may be appreciated that the exit pupil is a virtual aperture in an optical system. Only rays which pass through this virtual aperture can exit the system. Thus, the exit pupil describes a minimum diameter of the virtual image light after leaving the display system. The exit pupil defines the eyebox which comprises a spatial range of eye positions of the user in which the virtual images projected by the display system are visible.

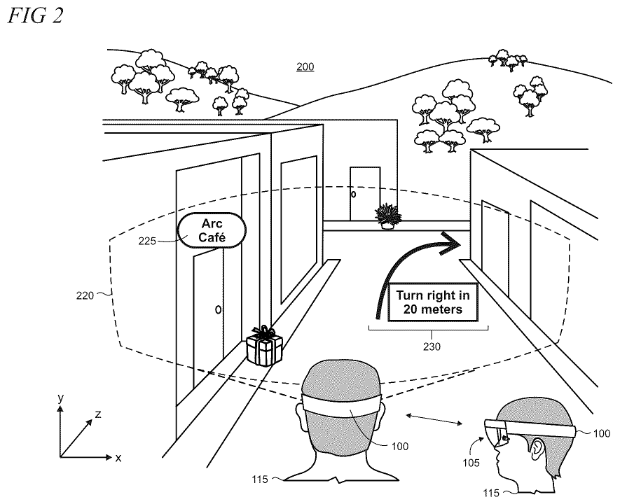

FIG. 2 shows the HMD device 100 worn by a user 115 as configured for mixed-reality experiences in which the display system 105 is configured as a near-eye display system having at least a partially transparent, see-through waveguide, among various other components. As noted above, a suitable display engine (not shown) generates virtual images that are guided by the waveguide in the display system to the user. Being see-through, the waveguide in the display system enables the user to perceive light from objects in the real world.

The see-through waveguide-based display system 105 can render images of various virtual objects that are superimposed over the real-world images that are collectively viewed using the see-through waveguide display to thereby create a mixed-reality environment 200 within the HMD device's FOV 220. It is noted that the FOV of the real world and the FOV of the virtual world are not necessarily identical, as the virtual FOV provided by the display system is typically a subset of the real FOV.

In the illustrative example shown in FIG. 2, the user 115 is physically walking in a real-world urban area that includes city streets with various buildings, stores, etc., with a countryside in the distance. The FOV 220 of the cityscape viewed on HMD device 100 changes as the user moves through the real-world environment and the device can render static and/or dynamic virtual images over the real-world view. In this illustrative example, the virtual images include a tag 225 that identifies a restaurant business and directions 230 to a place of interest in the city. The mixed-reality environment 200 seen visually on the display system 105 may also be supplemented by audio and/or tactile/haptic sensations produced by the HMD device in some implementations.

It is noted that FOV is just one of many parameters that are typically considered and balanced by HMD device designers to meet the requirements of a particular implementation. For example, such parameters may include eyebox size, brightness, transparency and duty time, contrast, resolution, color fidelity, depth perception, size, weight, form-factor, and user comfort (i.e., wearable, visual, and social), among others.

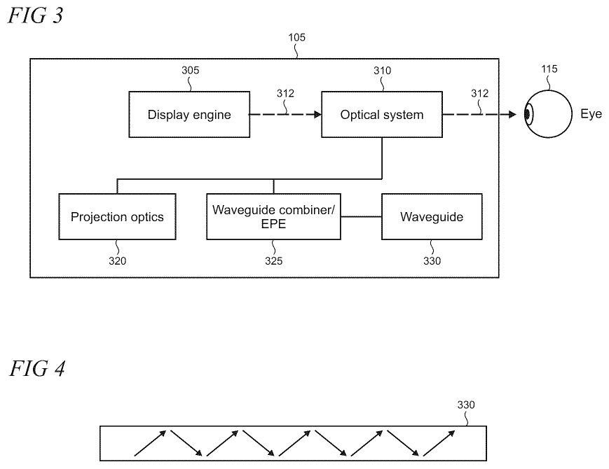

FIG. 3 shows illustrative components of the display system 105 that may be utilized in the HMD device in an illustrative mixed-reality embodiment. The display system includes a display engine 305 and an optical system 310 to provide virtual and real images to the user 115 over a light path 312. The optical system may include projection optics 320 (e.g., magnifying and/or collimating lenses, MEMS devices, or the like), and a waveguide combiner 325 that provides exit pupil expander (EPE) functionality that may be implemented using at least one waveguide 330.

Multiple DOEs are disposed on the waveguide 330 and configured to provide input-coupling of incident light into the waveguide, exit pupil expansion in two directions, and output-coupling of light out of the waveguide to an eye 115 of a system user. In illustrative embodiments, one or more of the DOEs may be implemented as SRGs.

The display engine 305 in the display system 105 may include one or more sources of virtual images (e.g., images representing objects from a virtual world that are not necessarily stereo images) that interoperate with the display system to deliver virtual images as a virtual display to a user's eye 115. The display engine may include, for example, RGB (red, green, blue) light emitting diodes (LEDs), LCOS (liquid crystal on silicon) devices, OLED (organic light emitting diode) arrays, MEMS devices, or any other suitable displays or micro-displays operating in transmission, reflection, or emission. The display engine may also include electronics such as processors, optical components such as mirrors and/or lenses, and/or mechanical and other components that enable a virtual display to be composed and provide one or more input optical beams to the optical system.

The waveguide 330 facilitates light transmission between the imager and the eye. One or more waveguides can be utilized in the near-eye display system because they are transparent and because they are generally small and lightweight (which is desirable in applications such as HMD devices where size and weight are generally sought to be minimized for reasons of performance and user comfort). For example, the waveguide 330 can enable the display engine 305 to be located out of the way, for example, on the side of the user's head or near the forehead, leaving only a relatively small, light, and transparent waveguide optical element in front of the eyes.

In an illustrative implementation, the waveguide 330 operates using a principle of total internal reflection (TIR), as shown in FIG. 4, so that light can be coupled among the various optical elements in the display system. TIR is a phenomenon which occurs when a propagating light wave strikes a medium boundary (e.g., as provided by the optical substrate of a waveguide) at an angle larger than the critical angle with respect to the normal to the surface. In other words, the critical angle (θ_{c}) is the angle of incidence above which TIR occurs, which is given by Snell's Law, as is known in the art. More specifically, Snell's law specifies that the critical angle (θ_{c}) is specified using the following equation:

$${θ}_{c} = {sin}^{- 1} ( n 2 / n 1 )$$

where θ_{c} is the critical angle for two optical mediums (e.g., the waveguide substrate and air or some other medium that is adjacent to the substrate) that meet at a medium boundary, n1 is the index of refraction of the optical medium in which light is traveling towards the medium boundary (e.g., the waveguide substrate, once the light is coupled therein), and n2 is the index of refraction of the optical medium beyond the medium boundary (e.g., air or some other medium adjacent to the waveguide substrate).

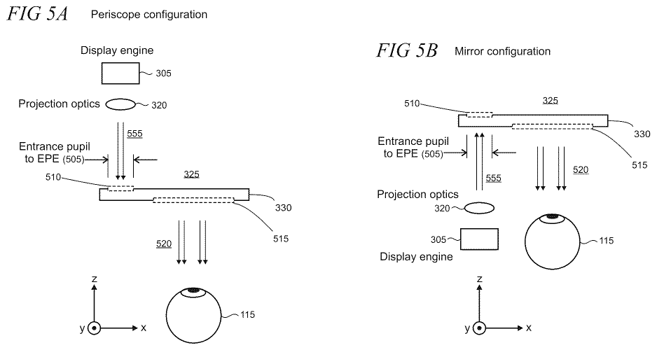

FIG. 5A shows a top view of a portion of an illustrative waveguide combiner 325, display engine 305, and projection optics 320 to provide virtual images to an eye of the user 115 using a periscope configuration. FIG. 5B shows a top view of mirror configuration for those components. In the periscope configuration, the virtual images from the display engine are coupled into the waveguide combiner on the opposite side of the virtual image output to the user. The mirror configuration may be utilized in some applications (for example, as with the HMD device 100 shown in FIG. 1) in which the display engine and user are located on the same side of the waveguide combiner.

It may be appreciated that a similar additional arrangement of components (not shown) would be used to provide virtual images to the user's other eye, for example, in a stereoscopic display. The waveguide combiner 325 includes EPE functionality and receives one or more input optical beams from a respective display engine as an entrance pupil 505 for virtual image light to produce one or more output optical beams with expanded exit pupil in one or two directions relative to the input. The expanded exit pupil typically facilitates a virtual display to be sufficiently sized to meet the various design requirements, such as eyebox size, image resolution, FOV, and the like, of a given optical system while enabling the imager and associated components to be relatively light and compact.

The waveguide combiner 325 utilizes an output-coupling DOE 515 that is disposed on the waveguide 330 and an input-coupling DOE 510 that is disposed on the opposite side. The output-coupling DOE is configured using SRGs with modulated grating depth, as described below. One or more redirection DOEs (not shown in FIG. 5) are disposed on the waveguide.

The DOEs are generally arrangeable in various configurations on the waveguide 330, for example, on the same side or different sides of the waveguide and may further be single- or double-sided in some implementations. In some implementations, the input-coupling and output-coupling DOEs 510 and 515 can be located on the side of the waveguide that is opposite from that shown. While the waveguide combiner is depicted as having a planar configuration, other shapes may also be utilized including, for example, curved or partially spherical shapes, in which case, SRG grating structures may be non-co-planar.

Exemplary output beams 520 from the waveguide combiner 325 are parallel to the exemplary input beams 555 that are output from the display engine 305 to the input-coupling DOE 510. In some implementations, the input beams are collimated such that the output beams are also collimated, as indicated by the parallel lines in the drawing. Typically, in waveguide-based combiners, the input pupil needs to be formed over a collimated field, otherwise each waveguide exit pupil will produce an image at a slightly different distance. This results in a mixed visual experience in which images overlap with different focal depths in an optical phenomenon known as focus spread.

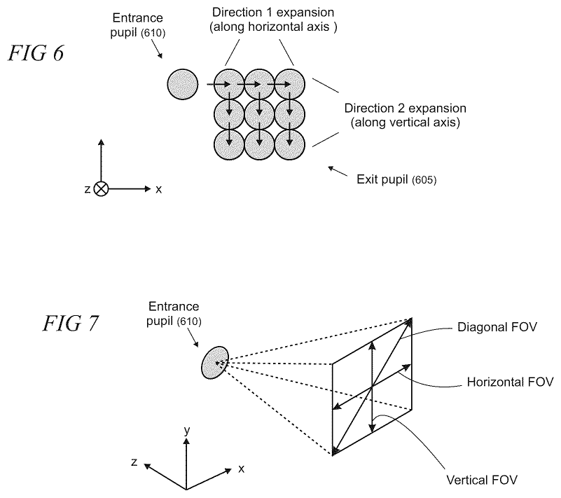

As shown in FIG. 6, the waveguide combiner 325 is configured to provide an expanded exit pupil 605 in two directions (i.e., along each of a first and second coordinate axis) compared with the entrance pupil 610 at the input-coupling DOE (not shown) of the waveguide combiner. The exit pupil is expanded in both the vertical and horizontal directions. It may be understood that the terms “left,” “right,” “up,” “down,” “direction,” “horizontal,” and “vertical” are used primarily to establish relative orientations in the illustrative examples shown and described herein for ease of description. These terms may be intuitive for a usage scenario in which the user of the near-eye display system is upright and forward facing, but less intuitive for other usage scenarios. The listed terms are not to be construed to limit the scope of the configurations (and usage scenarios therein) of near-eye display features utilized in the present arrangement. The entrance pupil 610 to the waveguide combiner at an input coupler is generally described in terms of FOV, for example, using horizontal FOV, vertical FOV, or diagonal FOV as shown in FIG. 7.

While conventional SRGs used in output-coupling DOEs can provide satisfactory performance in many applications, they are prone to a phenomenon referred to here as “eye glow” where virtual image light leaks to the real-world side of the waveguide combiner. As shown in FIG. 8, virtual images 805 in-coupled from a display engine (not shown) at the input-coupling DOE 810 are out-coupled as beams 815 to the user 115 via a conventionally-configured output-coupling DOE 820 towards the eye side 825 of a waveguide combiner 830. Simultaneously, some virtual image fields 835 are extracted from the waveguide combiner randomly towards the real-world side 840 of a display system. In typical multicolor HMD device configurations using conventional SRGs, the eye glow can be especially strong in a rainbow of colors. While the extracted field is undesired because it lowers the efficiency of the display system and wastes light, it can also present some issues during HMD device use, as discussed below. While FIG. 8 shows a periscope configuration for the waveguide combiner 830, it may be appreciated that the eye glow phenomenon resulting from virtual image light leaking to the real-world side of the display system also negatively affects waveguide combiners having a mirror configuration for in-coupling virtual image light.

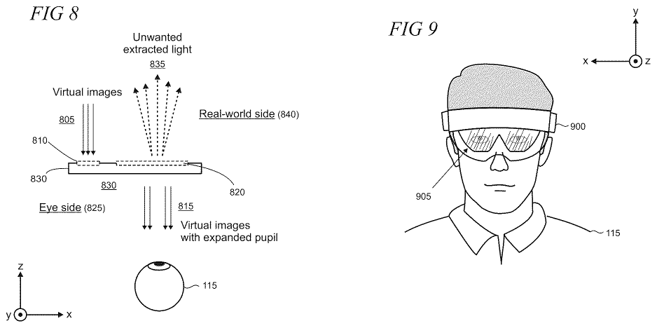

FIG. 9 shows a user 115 wearing an HMD device 900 that uses conventional SRGs in its display system. As indicated by reference numeral 905, eye glow directed towards the real-world side of the device manifested by the unwanted extracted field can partially or completely obscure the eyes of the user. In some mixed-reality environments, for example, a “hybrid presence” is experienced in which the user has a sense of presence of both virtual and real human beings. If eyes are replaced by eye glow, then eye contact among device users can be difficult to maintain. This can diminish the experience of a real presence and thereby reduce the social comfort for the HMD device user.

In other HMD device use scenarios, the visibility of the forward projecting eye glow to others can negatively impact a user's experience, for example, at nighttime or in dark environments. Readily perceived eye glow may represent a security risk when an HMD device user's location should not be revealed, for example in security/police/military settings.

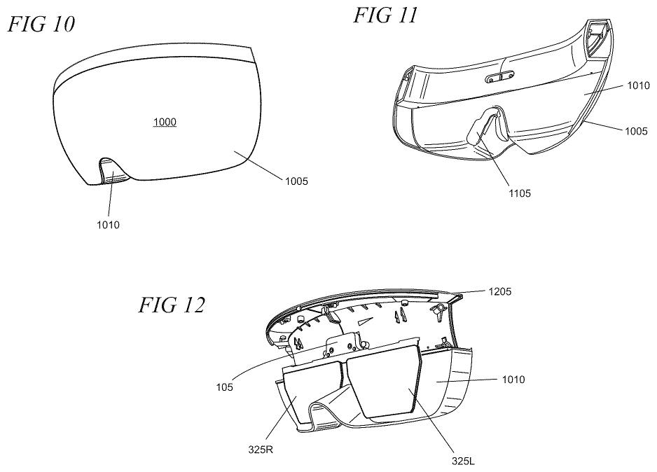

FIGS. 10 and 11 show respective front and rear views of an illustrative example of a visor 1000 that incorporates an internal display system 105 (FIGS. 1 and 2) that is used in the HMD device 100. The visor, in some implementations, may be sealed to protect the internal display system. The visor typically interfaces with other components of the HMD device such as head-mounting/retention systems and other subsystems including sensors, power management, controllers, etc., as illustratively described in conjunction with FIGS. 10 and 11. Suitable interface elements (not shown) including snaps, bosses, screws, and other fasteners, etc. may also be incorporated into the visor.

The visor 1000 may include see-through front and rear shields, 1005 and 1010 respectively, that can be molded using transparent or partially transparent materials to facilitate unobstructed vision to the display system 105 and the surrounding real-world environment. Treatments may be applied to the front and rear shields such as tinting, mirroring, anti-reflective, anti-fog, and other coatings, and various colors and finishes may also be utilized. The front and rear shields are affixed to a chassis 1205 shown in the disassembled view in FIG. 12.

The visor 1000 can physically protect sensitive internal components, including the display system 105, when the HMD device is operated and during normal handling for cleaning and the like. The display system in this illustrative example includes left and right waveguide combiners 325L and 325R that respectively provide virtual images to the user's left and right eyes for mixed- and/or virtual-reality applications. The visor can also protect the display system from environmental elements and damage should the HMD device be dropped or bumped, impacted, etc.

As shown in FIG. 11, the rear shield 1010 is configured in an ergonomically suitable form 1105 to interface with the user's nose, and nose pads and/or other comfort features can be included (e.g., molded-in and/or added-on as discrete components). In some applications, the visor 1000 can also incorporate some level of optical diopter curvature (i.e., eye prescription) within the molded shields in some cases.

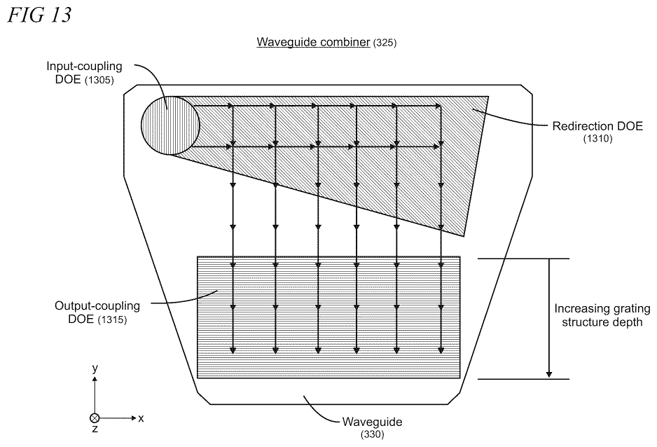

FIG. 13 shows an illustrative waveguide combiner 325 having multiple diffractive optical elements (DOEs) that may be used in an embodiment of the display system 105 (FIG. 1) to provide input coupling, expansion of the exit pupil in two directions, and output coupling of virtual images from the display engine 305 (FIG. 3) to the user's eye. Each DOE is an optical element comprising periodic SRG grating structures that modulate various properties of virtual image light in a periodic pattern such as the direction of optical axis, optical path length, and the like. The grating structures can be periodic in one dimension such as one-dimensional (1D) grating and/or be periodic in two dimensions such as two-dimensional (2D) grating. The arrows indicate the direction of virtual image propagation in the waveguide 330.

The waveguide combiner 325 includes an input-coupling DOE 1305, an output-coupling DOE 1315, and an intermediate redirection DOE 1310 that couples light between the input-coupling and output-coupling DOEs. The input-coupling DOE is configured to couple image light comprising one or more virtual imaging beams from the display engine into the waveguide 330. The redirection DOE expands the exit pupil in a first direction along a first coordinate axis (e.g., horizontal), and the output-coupling DOE expands the exit pupil in a second direction along a second coordinate axis (e.g., vertical) and couples light out of the waveguide to the user's eye (i.e., outwards from the plane of the drawing page). As the light propagates in the redirection DOE (horizontally from left to right in the drawing), it is also diffracted (in the downward direction) to the output-coupling DOE.

While DOEs are shown in this illustrative example using a single input-coupling DOE 1305 disposed to the left of the redirection DOE 1310, which is located above the output-coupling DOE 1315, in some implementations, the input-coupling DOE may be centrally positioned within the waveguide and one or more redirection DOEs can be disposed laterally from the input-coupling DOE to enable light to propagate to the left and right while providing for exit pupil expansion along the first direction. It may be appreciated that other numbers and arrangements of DOEs may be utilized to meet the needs of a particular implementation. In other implementations of waveguide combiners using the present principles, other types of optical components such as reflective optical elements, hologram couplers, and/or metasurface couplers may be utilized for one or more of an input coupling or redirection coupling.

The waveguide combiner 325 is configurable to support monochromatic or polychromatic rendering of virtual images in the display system of the HMD device 100. For monochromatic applications, a single-layer waveguide combiner is generally utilized to render monochromatic virtual images over views of the real world. For polychromatic applications, the waveguide combiner is typically implemented using multiple waveguide plates and associated DOEs in a stacked arrangement. However, in some alternative polychromatic applications, for relatively narrow FOVs, all colors can be guided using a single waveguide plate.

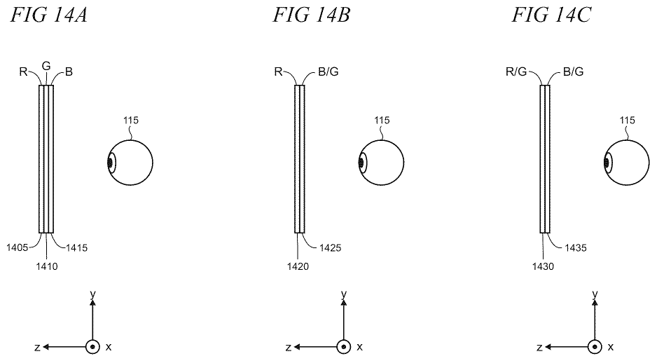

FIG. 14A shows a stack of three waveguide plates (the DOEs are not shown for clarity in exposition), indicated by reference numerals 1405, 1410, and 1415, in which each plate handles a separate color of an RGB (red, green, blue) color space. While RGB is commonly utilized, other suitable color spaces are usable to meet the requirements of a given application. It is noted that the order of the RGB plates is arbitrary in the drawing, and variations from what is shown may be utilized.

Two waveguide plates are alternatively utilizable to support the RGB color space. As shown in FIG. 14B, a plate 1420 supports the red component while a second plate 1425 in the stack supports both the green and blue components of the RGB color space. As shown in FIG. 14C, a plate 1430 supports the red component of the RGB color space over the entirety of the FOV of the display and also supports a selected portion of the FOV of the green component. Plate 1435 supports the blue component over the entirety of the FOV and the remaining FOV of the green component of the RGB color space. Other suitable variations in plate configuration and color space splits may also be utilized to meet particular requirements while still benefiting from the present principles.

The design of current DOEs typically implements control of light diffraction and propagation by the configuration of grating structures on a nanometer scale. Grating period, orientation, slant angle, and grating depth are exemplary parameters that are selected and balanced to achieve performance of a DOE that meets design requirements. For example, in current designs, the depth of grating structures that are closest to the light input of a DOE are typically shallow to enable suitable light propagation through the DOE to fill in all angles of the FOV with satisfactory color balance and display uniformity and brightness with fewest artifacts. However, when gratings have a shallow design, when fabricated during manufacturing, the structures are realized as binary gratings in actual practice because there is generally insufficient dimensional freedom to realize effective slanted gratings. It may be appreciated that shallow gratings are typically responsible for the greatest contribution of virtual light leakage to the real-world side of the display system.

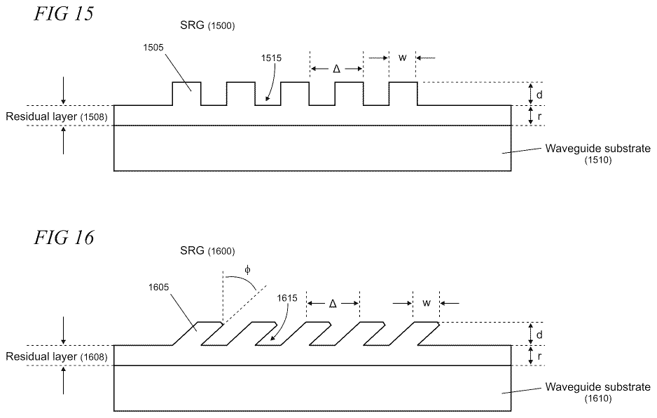

FIG. 15 shows a profile of a portion of a binary SRG 1500 in an out-coupling DOE having straight (i.e., non-slanted) grating structures (representatively indicated by reference numeral 1505 and commonly referred to as grating bars, grating lines, or simply “gratings”) that are formed in a waveguide substrate 1510. The grating period is represented by Δ, the grating depth by d, and bar width by w. The fill factor is the ratio between width and grating period. A common limitation of binary gratings is that light is almost equally diffracted to the eye side and the unwanted real-world side of the out-coupling DOE as forward-propagating parasitic losses.

By comparison to the binary grating features of the SRG 1500 in FIG. 15, FIG. 16 shows a profile of a portion of SRG 1600, with slanted grating features, which is usable in an output-coupling DOE. As shown, the grating features (representatively indicated by reference numeral 1605) are slanted at some predetermined angle φ with a groove period of Δ. Slanted gratings can be very versatile elements and generally provide SRG design flexibility because their spectral and angular bandwidths can be tuned by the slant angles. Front and back slant angles in a same period (or from period to period) can be carefully tuned to achieve the desired angular and spectral operation.

Both the SRGs 1500 and 1600 include a residual layer 1508 and 1608, respectively, with height r that commonly results from an incomplete or partial evacuation of resin from the trenches 1515 and 1615 between the grating structures during fabrication. The residual layer operates as a flat interface which may act as a Fresnel reflection surface that can limit the FOV of the fields that propagate from the waveguide substrate to the gratings. Unwanted Fresnel reflections generally increase as the difference in refractive indexes of the SRG and underlying optical substrate of the waveguide increases.

The limitations arising from shallow gratings with respect to binary realization can be addressed, in a first illustrative embodiment of the present principles, by an output-coupling DOE having depth-modulated gratings that implement a gradient refractive index in combination with a thickness-modulated residual layer. In the illustrative example shown in FIG. 13, the output-coupling DOE 1315 in the waveguide combiner 325 includes an SRG with depth-modulated gratings with increasing depth along the propagation direction (e.g., downward in the drawing). For example, in this particular example, but not by way of limitation, the grating depth varies from approximately 30 to 190 nm with the shallowest gratings at the top of the output-coupling DOE nearest to the redirection DOE 1310. In some embodiments, the grating structure depth modulation is implemented linearly over the output-coupling DOE.

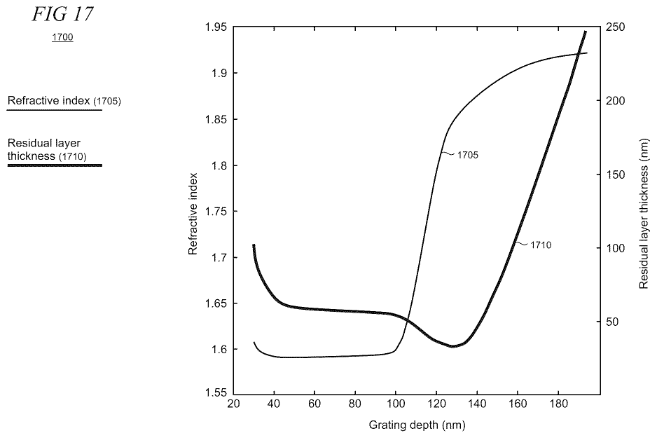

FIG. 17 is an illustrative graph 1700 that plots refractive index for grating structures and residual layer thickness in the output-coupling DOE as functions of grating depth. It is emphasized that the curves shown are intended to be illustrative and not limiting. As shown, the refractive index curve 1705 of the SRG structures has a gradient profile which includes an initial refractive index value above 1.6 for the shallowest gratings before including a substantially constant region from approximately 40 to 100 nm of grating depth in which the refractive index is approximately 1.6. The curve further includes a transition region between approximately 100 and 130 nm of grating structure depth in which the refractive index of grating structures increases from approximately 1.6 to 1.85. The refractive index curve includes a concave down portion in which the refractive index increases from approximately 1.85 to a maximum value of around 1.925 from a grating depth of approximately 120 nm to the maximum grating depth of about 190 nm.

The residual layer thickness curve 1710 follows a modulated thickness profile that includes an initial residual thickness value above 100 nm for the shallowest gratings of the output-coupling DOE. The residual layer thickness decreases to approximately 50 nm in a constant thickness region between approximately 45 to 90 nm of grating structure depth. The residual layer thickness decreases to a minimum thickness value of approximately 30 nm within a transition region between approximately 100 to 130 nm of grating structure depth. The curve further includes a variable thickness region between approximately 130 to 195 nm of grating structure depth in which the residual layer thickness increases from approximately 30 to 230 nm.

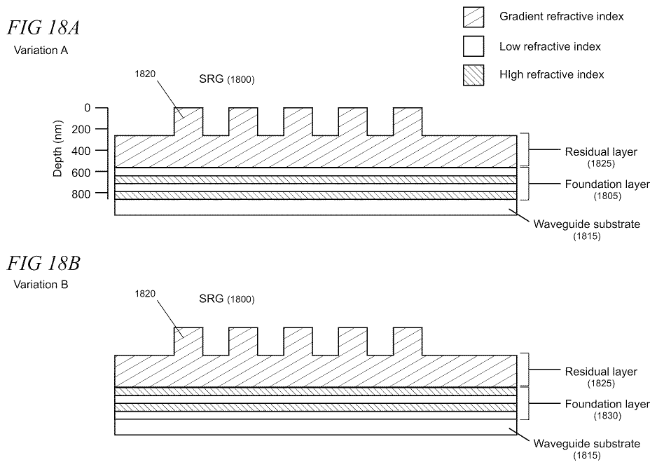

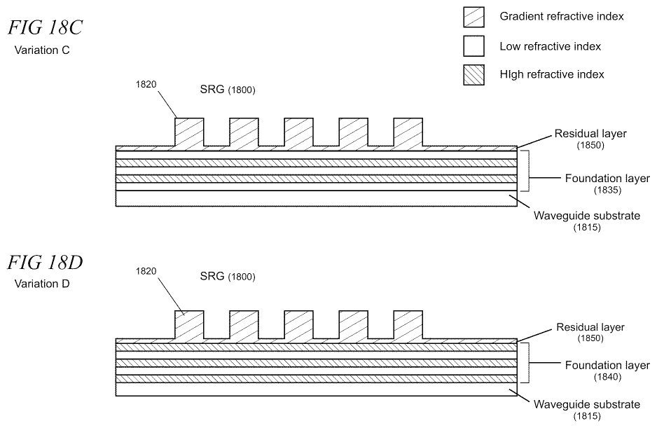

FIGS. 18A, 18B, 18C, and 18D show alternative variations of a second illustrative embodiment of the present principles in which a foundation layer is located between an SRG 1800 and the waveguide substrate 1815. The SRG comprises grating structures 1820 over a residual layer 1825. The grating structures are straight in this illustrative example, but slanted gratings are alternatively utilizable in some applications. The foundation layer has a refractive index that is selected to provide a contrast with the refractive index of the SRG. For example, if the SRG (including the grating structures and residual layer) has a relatively high refractive index, then the refractive index of the foundation layer is relatively low. Conversely, the refractive index of the foundation layer may be relatively high if the refractive index of the SRG is relatively low.

In some embodiments, the foundation layer can comprise two or more sub-layers in which each sub-layer has a contrasting refractive index to an adjacent sub-layer. For example, as shown in FIG. 18A, the foundation layer 1805 comprises four sub-layers that alternate between high and low refractive indices. The refractive index of the SRG 1800 (including both the grating structures 1820 and residual layer 1825) is configured to have a medium value between the high and low values used in the foundation layer. The refractive index of the SRG, or of its constituent components, may also follow a gradient profile, as discussed above, in some implementations.

In FIG. 18A showing an illustrative variation A for the SRG 1800, a low refractive index sub-layer is located immediately adjacent to the residual layer 1825 of the SRG 1800. FIG. 18B shows an illustrative variation B with four sub-layers for a foundation layer 1830 in which a high refractive index sub-layer location is immediately adjacent to the residual layer of the SRG.

FIG. 18C shows an illustrative variation C of the SRG 1800 in which a relatively thin residual layer 1850 is utilized. For example, the residual layer can have a thickness between approximately zero to 20 nm. In variation C, five sub-layers are illustratively utilized in the foundation layer 1835 with a low refractive index sub-layer being located immediately adjacent to the residual layer. FIG. 18D shows an illustrative variation D of the SRG using five sub-layers in the foundation layer 1840 in which a high refractive index sub-layer location is immediately adjacent to the residual layer 1850 of the SRG.

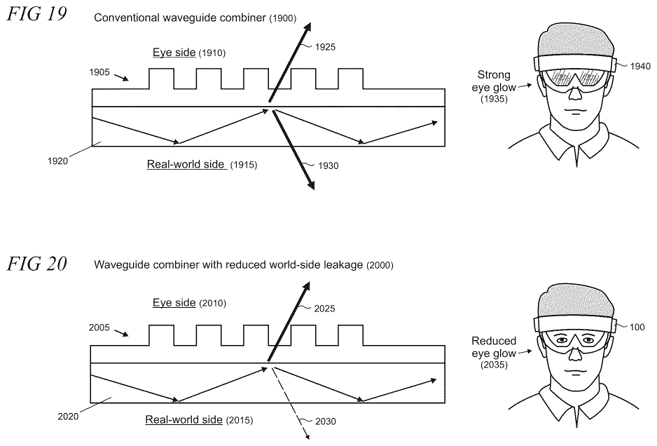

FIG. 19 shows an output-coupling DOE in a conventional waveguide combiner 1900 that exhibits unwanted leakage of virtual image light to the real-world side of the combiner. In general, the characteristics of the SRG 1905 from the particular combination of parameters selected for its design results in low Bragg selectivity over the wavelengths and FOV angles of interest. When Bragg selectivity is low, instead of diffracting light primarily to a single desired order, the waveguide combiner allows for virtual image light to be diffracted into multiple unwanted orders. As shown, this characteristic results in diffraction occurring on both the eye side 1910 and real-world side 1915 of the waveguide 1920, as indicated by arrows 1925 and 1930. The diffraction to the real-world side causes strong eye glow 1935 as shown in the illustrative HMD device 1940 on the right-hand side of the drawing.

By comparison, FIG. 20 shows an output-coupling DOE in a waveguide combiner 2000 that includes the first and/or second embodiments of the present principles described above. This output-coupling DOE has stronger Bragg selectivity to thereby reduce eye glow 2035 in the HMD device 100. While relatively strong diffraction occurs to the eye side 2010 of the waveguide 2020, as indicated by arrow 2025, the unwanted leakage of virtual image light due to diffraction 2030 on the real-world side 2015 is lowered because the SRG 2005 provides a higher extinction ratio between transmission and reflection fundamental orders.

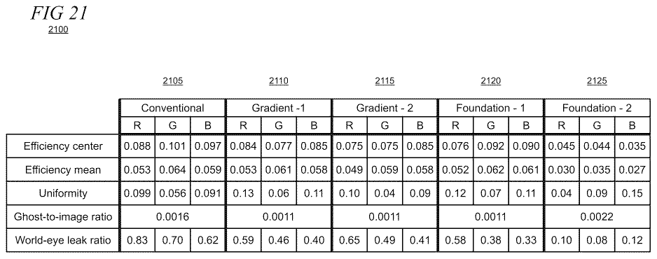

FIG. 21 is a table 2100 that compares performance metrics among a conventional output-coupling DOE and output-coupling DOEs that include embodiments of the present principles. The performance metrics include efficiency in the center of the FOV of the display and mean efficiency across the entirety of the FOV. Higher efficiency values mean that more virtual image light is being directed into the desired diffraction orders. Uniformity refers to the consistency of brightness across the FOV (lower values in the table are better). Ghost to image ratio deals with relative intensity of unwanted “ghost” images resulting from diffraction to unwanted diffraction orders compared to the desired main image (lower values in the table are better). World-eye leak ratio deals with the relative amounts of light being directed to the world side of the waveguide combiner compared to the eye side (lower values in the table are better).

Performance metrics for the conventional output-coupling DOE are shown in column 2105. The first embodiment described above for gradient refractive index and modulated residual layer thickness is shown for each of two different designs in columns 2110 and 2115. Design 1 uses a configuration that is optimized for efficiency and design 2 is optimized for display uniformity. The second embodiment described above for the foundation layer with contrasting refractive index is shown for each of two designs in columns 2120 and 2125. Design 1 uses a configuration that is optimized for efficiency and design 2 is optimized for display uniformity.

Table 2100 in FIG. 21 indicates that performance of the output-coupling DOE as arranged in accordance with the present principles compares favorably with conventional designs with a significant reduction in world-side leakage of virtual image light.

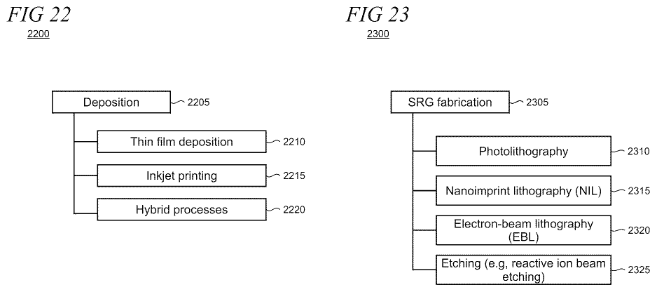

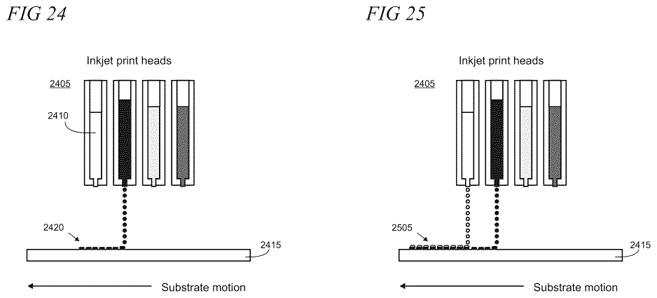

The SRGs in the output-coupling DOE in the present waveguide combiner with reduced world-side leakage can be fabricated by suitably modifying various known techniques. FIG. 22 is an illustrative taxonomy 2200 of optical material deposition techniques 2205 that may be suitably adapted in initial processes to create the SRGs. The techniques include, for example and without limitation, thin film deposition processes 2210, inkjet printing 2215, and hybrid processes 2220 that combine thin film deposition with inkjet printing and/or other processes. FIG. 23 is an illustrative taxonomy 2300 of SRG fabrication techniques 2305 that may be suitably adapted to produce the final SRGs. The techniques include, for example and without limitation, photolithography 2310, nanoimprint lithography (NIL) 2315, electron-beam lithography (EBL) 2320, and etching 2325 (e.g., reactive ion beam etching (RIBE)).

One or more of the deposition techniques 2205 are utilized to place optical materials on a substrate. The deposited materials are subsequently utilized with one or more of the SRG fabrication techniques 2305 to create the appropriate grating structures and residual layers. In some cases, multiple cycles of deposition and fabrication are utilized to build up the desired SRG structures.

The thin film deposition techniques 2210 include, for example and without limitation, spin and dip coating, physical vapor deposition (PVD) (e.g., thermal evaporation, electron-beam evaporation, sputtering, and pulsed laser deposition (PLD)), and chemical vapor deposition (CVD) (e.g., atmospheric pressure CVD (APCVD), low-pressure CVD (LPCVD), plasma-enhanced CVD (PECVD), and atomic layer deposition (ALD)).

Thin film deposition techniques 2210 are generally well suited to fabricate the second illustrative foundation layer embodiment of the present principles discussed above with reference to FIGS. 18A, 18B, 18C, and 18D. For example, spin coating is a widely used technique for depositing uniform thin films of optical resins and other materials. Film thicknesses on the nanometer scale are readily achievable in well controlled spin coating processes. By adjusting the spin coating parameters, the film thicknesses for the foundation layers may be fine-tuned to meet appropriate design requirements.

The inkjet printing process 2215 utilizes grayscale inkjet printing technologies that are adapted to apply photocurable resins in film layers over a see-through optical substrate that provides an underlying waveguide to an SRG. The photocurable resins have different refractive indexes to provide some design freedom in defining the refractive index gradient over the spatial area of the SRG in an output-coupling DOE. In addition to resins with different refractive indexes, the grayscale inkjet application process enables droplets of resins in the films to have different sizes and be spatially patterned in two-dimensional space. This spatial variation enables additional design freedom in defining a refractive index gradient. In addition, the flexibility provided by inkjet printing makes it well suited to fabricate the thickness-modulated residual layer aspect of the first illustrative embodiment of the present principles discussed above with reference to FIG. 17.

FIG. 24 shows an illustrative array 2405 of inkjet print heads each applying a different resin with a unique refractive index from a resin reservoir (representatively indicated by reference numeral 2410). Four inkjet print heads are shown in the drawing for illustration purposes, but the actual number utilized in a production environment is typically orders of magnitude higher and can vary by implementation and SRG design requirements. Various approaches may be utilized for the generation of inkjet droplets including, for example, continuous inkjet (CIJ) printing and drop on demand (DOD) inkjet printing. In the example shown, an optical substrate 2415 moves relative to the inkjet print head array to enable the resin droplets to be deposited as a film 2420.

Grayscale inkjet printing is further adapted, in some applications of the present principles, as illustratively shown in FIG. 25, to use multiple inkjet print heads simultaneously or in succession to enable resins of the same or different refractive indexes to be stacked in a third dimension (i.e., in a direction normal to the substrate) in a film layer 2505.

Using the present techniques, resins with the different refractive indexes and droplet size/volumes may be patterned in arrays defined in three-dimensional space in a wet mixing process prior to being cured in a subsequent grating imprinting or replication process such as jet and flash imprint lithography (J-FIL), a form of nanoimprinting lithography (NIL). In some implementations, as shown in FIG. 26, the resin patterning is assisted by relative motion between the print head array 2405 and the substrate along multiple axes, typically in a two-dimensional x-y plane, although relative motion in the z direction may also be utilized in some cases.

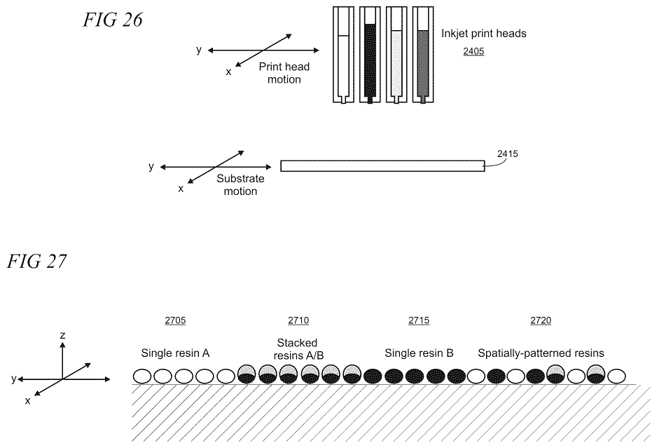

FIG. 27 provides an illustrative example of the large scope of design freedom provided by the present grayscale inkjet printing adapted to use variable refractive indexes for different inkjet photocurable resins in a wet mix process. Different resins can be applied in spatial patterns in three-dimensional space, including variations along the plane of the substrate and normal to the substrate by stacking film layers. It may be appreciated that increasing the number of distinct resins and varying the resin droplet size in the grayscale process can further increase the design freedom to implement spatially gradient refractive index gratings for SRGs. As shown, for example, inkjet patterns may comprise one or more of a single resin A 2705, stacked resins A/B 2710, a single resin B 2715, and spatially patterned resins 2720.

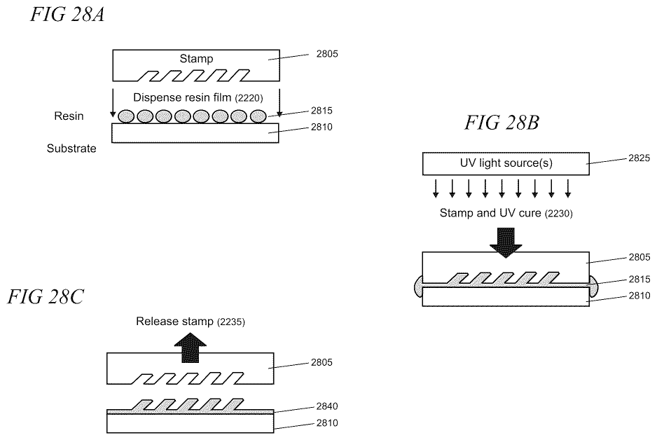

FIGS. 28A, 28B, and 28C show an illustrative process for manufacturing SRGs having depth-modulated gratings using NIL processing such as J-FIL. In FIG. 28A, an elastomer (i.e., “soft”) stamp 2805 is produced from a hard master. The stamp is aligned with an optical substrate 2810 configured as a waveguide on which a deformably-viscous photocurable resin layer 2815 is dispensed using the inkjet printing process discussed above, as indicated by reference numeral 2820.

In FIG. 28B, the stamp 2805 is pressed against the resin layer 2815 using mechanical force to imprint micro-/nanostructures (collectively referred to as nanostructures) in the resin which are then cured using light from one or more UV light sources 2825, as indicated by reference numeral 2830, via cross-linking in the resin. In typical implementations, the mechanical force is relatively low compared to conventional thermal NIL processing and the imprinting can be carried out at room temperature.

In FIG. 28C, the stamp 2805 is released from the cured resin, as indicated by reference numeral 2835. After the stamp is detached, a negative pattern of the stamp is imprinted on the cured resin layer to produce an NIL-imprinted SRG 2840. Some additional curing or other post-processing may be utilized (not shown) in some cases to further develop SRG features or provide additional shaping or treatment. For example, the SRG may be apodized using ashing in a plasma, or atomic layer deposition (ALD) may be utilized to increase resistance of the SRG to variations in environmental factors such as temperature, pressure, humidity, etc.

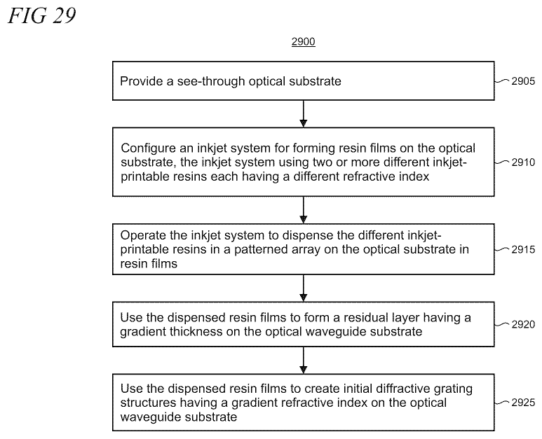

FIG. 29 is a flowchart of an illustrative method 2900 for fabricating an SRG that out-couples virtual images over views, by a user, of a real world. Unless specifically stated, the methods or steps shown in the flowcharts and described in the accompanying text are not constrained to a particular order or sequence. In addition, some of the methods or steps thereof can occur or be performed concurrently and not all the methods or steps have to be performed in a given implementation depending on the requirements of such implementation and some methods or steps may be optionally utilized.

Block 2905 includes providing a see-through optical substrate. Block 2910 includes configuring an inkjet system for forming resin films on the optical substrate, the inkjet system using two or more different inkjet-printable resins each having a different refractive index.

Block 2915 includes operating the inkjet system to dispense the different inkjet-printable resins in a patterned array on the optical substrate in resin films. Block 2920 includes using the dispensed resin films to form a residual layer having a gradient thickness on the optical waveguide substrate. Block 2925 includes using the dispensed resin films to create initial diffractive grating structures having a gradient refractive index on the optical waveguide substrate.

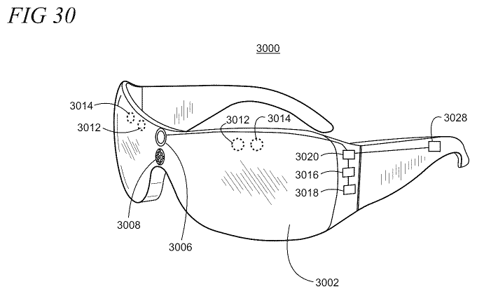

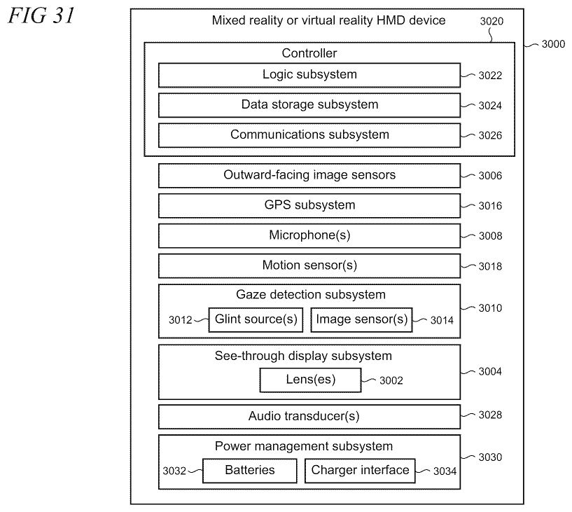

FIG. 30 shows one particular illustrative example of a mixed-reality HMD device 3000, and FIG. 31 shows a functional block diagram of the device 3000. The HMD device 3000 provides an alternative form factor to the HMD device 100 shown in FIGS. 1 and 2 and described in the accompanying text. HMD device 3000 comprises one or more lenses 3002 that form a part of a see-through display subsystem 3004, so that images may be displayed using lenses 3002 (e.g., using projection onto lenses 3002, one or more waveguide systems, such as a near-eye display system, incorporated into the lenses 3002, and/or in any other suitable manner).

HMD device 3000 further comprises one or more outward-facing image sensors 3006 configured to acquire images of a background scene and/or physical environment being viewed by a user and may include one or more microphones 3008 configured to detect sounds, such as voice commands from a user. Outward-facing image sensors 3006 may include one or more depth sensors and/or one or more two-dimensional image sensors. In alternative arrangements, as noted above, a mixed-reality or virtual-reality display system, instead of incorporating a see-through display subsystem, may display mixed-reality or virtual-reality images through a viewfinder mode for an outward-facing image sensor.

The HMD device 3000 may further include a gaze detection subsystem 3010 configured for detecting a direction of gaze of each eye of a user or a direction or location of focus, as described above. Gaze detection subsystem 3010 may be configured to determine gaze directions of each of a user's eyes in any suitable manner. For example, in the illustrative example shown, a gaze detection subsystem 3010 includes one or more glint sources 3012, such as IR (Infrared) light or visible sources as described above, that are configured to cause a glint of light to reflect from each eyeball of a user, and one or more image sensors 3014, such as inward-facing sensors, that are configured to capture an image of each eyeball of the user. Changes in the glints from the user's eyeballs and/or a location of a user's pupil, as determined from image data gathered using the image sensor(s) 3014, may be used to determine a direction of gaze.

In addition, a location at which gaze lines projected from the user's eyes intersect the external display may be used to determine an object at which the user is gazing (e.g., a displayed virtual object and/or real background object). Gaze detection subsystem 3010 may have any suitable number and arrangement of light sources and image sensors. In some implementations, the gaze detection subsystem 3010 may be omitted.

The HMD device 3000 may also include additional sensors. For example, HMD device 3000 may comprise a global positioning system (GPS) subsystem 3016 to allow a location of the HMD device 3000 to be determined. This may help to identify real-world objects, such as buildings, etc., that may be located in the user's adjoining physical environment.

The HMD device 3000 may further include one or more motion sensors 3018 (e.g., inertial, multi-axis gyroscopic, or acceleration sensors) to detect movement and position/orientation/pose of a user's head when the user is wearing the system as part of a mixed-reality or virtual-reality HMD device. Motion data may be used, potentially along with eye-tracking glint data and outward-facing image data, for gaze detection, as well as for image stabilization to help correct for blur in images from the outward-facing image sensor(s) 3006. The use of motion data may allow changes in gaze direction to be tracked even if image data from outward-facing image sensor(s) 3006 cannot be resolved.

In addition, motion sensors 3018, as well as microphone(s) 3008 and gaze detection subsystem 3010, also may be employed as user input devices, such that a user may interact with the HMD device 3000 via gestures of the eye, neck and/or head, as well as via verbal commands in some cases. It may be understood that sensors illustrated in FIGS. 30 and 31 and described in the accompanying text are included for the purpose of example and are not intended to be limiting in any manner, as any other suitable sensors and/or combination of sensors may be utilized to meet the needs of a particular implementation. For example, biometric sensors (e.g., for detecting heart and respiration rates, blood pressure, brain activity, body temperature, etc.) or environmental sensors (e.g., for detecting temperature, humidity, elevation, UV (ultraviolet) light levels, etc.) may be utilized in some implementations.

The HMD device 3000 can further include a controller 3020 such as one or more processors having a logic subsystem 3022 and a data storage subsystem 3024 in communication with the sensors, gaze detection subsystem 3010, display subsystem 3004, and/or other components through a communications subsystem 3026. The communications subsystem 3026 can also facilitate the display system being operated in conjunction with remotely located resources, such as processing, storage, power, data, and services. That is, in some implementations, an HMD device can be operated as part of a system that can distribute resources and capabilities among different components and subsystems.

The storage subsystem 3024 may include instructions stored thereon that are executable by logic subsystem 3022, for example, to receive and interpret inputs from the sensors, to identify location and movements of a user, to identify real objects using surface reconstruction and other techniques, and dim/fade the display based on distance to objects so as to enable the objects to be seen by the user, among other tasks.

The HMD device 3000 is configured with one or more audio transducers 3028 (e.g., speakers, earphones, etc.) so that audio can be utilized as part of a mixed-reality or virtual-reality experience. A power management subsystem 3030 may include one or more batteries 3032 and/or protection circuit modules (PCMs) and an associated charger interface 3034 and/or remote power interface for supplying power to components in the HMD device.

It may be appreciated that the HMD device 3000 is described for the purpose of example, and thus is not meant to be limiting. It may be further understood that the display system may include additional and/or alternative sensors, cameras, microphones, input devices, output devices, etc. than those shown without departing from the scope of the present arrangement. Additionally, the physical configuration of an HMD device and its various sensors and subcomponents may take a variety of different forms without departing from the scope of the present arrangement.

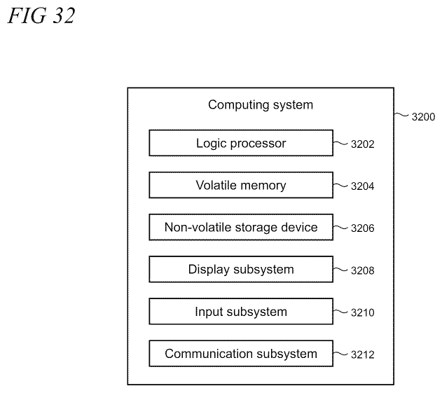

FIG. 32 schematically shows an illustrative example of a computing system that can utilize SRGs that are replicated using the present principles. Computing system 3200 is shown in simplified form. Computing system 3200 may take the form of one or more personal computers, server computers, tablet computers, home-entertainment computers, network computing devices, gaming devices, mobile computing devices, mobile communication devices (e.g., smartphone), wearable computers, and/or other computing devices.

Computing system 3200 includes a logic processor 3202, volatile memory 3204, and a non-volatile storage device 3206. Computing system 3200 may optionally include a display subsystem 3208, input subsystem 3210, communication subsystem 3212, and/or other components not shown in FIG. 32.

Logic processor 3202 includes one or more physical devices configured to execute instructions. For example, the logic processor may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more processors configured to execute software instructions. In addition, or alternatively, the logic processor may include one or more hardware or firmware logic processors configured to execute hardware or firmware instructions. Processors of the logic processor may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects may be run on different physical logic processors of various different machines.

Non-volatile storage device 3206 includes one or more physical devices configured to hold instructions executable by the logic processors to implement the methods and processes described herein. When such methods and processes are implemented, the state of non-volatile storage device 3206 may be transformed (e.g., to hold different data).

Non-volatile storage device 3206 may include physical devices that are removable and/or built-in. Non-volatile storage device 3206 may include optical memory (e.g., CD, DVD, HD-DVD, Blu-Ray Disc, etc.), semiconductor memory (e.g., ROM, EPROM, EEPROM, FLASH memory, etc.), and/or magnetic memory, or other mass storage device technology. Non-volatile storage device 3206 may include non-volatile, dynamic, static, read/write, read-only, sequential-access, location-addressable, file-addressable, and/or content-addressable devices. It will be appreciated that non-volatile storage device 3206 is configured to hold instructions even when power is cut to the non-volatile storage device 3206.

Volatile memory 3204 may include physical devices that include random access memory. Volatile memory 3204 is typically utilized by logic processor 3202 to temporarily store information during processing of software instructions. It will be appreciated that volatile memory 3204 typically does not continue to store instructions when power is cut to the volatile memory 3204.

Aspects of logic processor 3202, volatile memory 3204, and non-volatile storage device 3206 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The term “program” may be used to describe an aspect of computing system 3200 typically implemented in software by a processor to perform a particular function using portions of volatile memory, which function involves transformative processing that specially configures the processor to perform the function. Thus, a program may be instantiated via logic processor 3202 executing instructions held by non-volatile storage device 3206, using portions of volatile memory 3204. It will be understood that different programs may be instantiated from the same application, service, code block, object, library, routine, API, function, etc. Likewise, the same program may be instantiated by different applications, services, code blocks, objects, routines, APIs, functions, etc. The term “program” may encompass individual or groups of executable files, data files, libraries, drivers, scripts, database records, etc.

When included, display subsystem 3208 may be used to present a visual representation of data held by non-volatile storage device 3206. This visual representation may take the form of a graphical user interface (GUI). As the herein described methods and processes change the data held by the non-volatile storage device, and thus transform the state of the non-volatile storage device, the state of display subsystem 3208 may likewise be transformed to visually represent changes in the underlying data. Display subsystem 3208 may include one or more display devices utilizing virtually any type of technology; however, one utilizing a MEMS projector to direct laser light may be compatible with the eye-tracking system in a compact manner. Such display devices may be combined with logic processor 3202, volatile memory 3204, and/or non-volatile storage device 3206 in a shared enclosure, or such display devices may be peripheral display devices.

When included, input subsystem 3210 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 3212 may be configured to communicatively couple various computing devices described herein with each other, and with other devices. Communication subsystem 3212 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 3200 to send and/or receive messages to and/or from other devices via a network such as the Internet.

Various exemplary embodiments of the present mixed-reality waveguide combiner with reduced world-side leakage are now presented by way of illustration and not as an exhaustive list of all embodiments. An example includes a see-through waveguide combiner, employable by a user in a mixed-reality display system, the waveguide combiner combining virtual images with views of a real world by the user, comprising: a transparent substrate propagating virtual images in-coupled from a display engine in total internal reflection along a propagation direction; and an output-coupling surface relief grating (SRG) disposed on the substrate, the SRG including grating structures having increasing depth along the propagation direction of the virtual images, the output-coupling SRG configured for output-coupling the virtual images from the see-through waveguide combiner to an eye of the user, wherein the output-coupling SRG comprises a residual layer underneath the grating structures, the residual layer being disposed over the substrate and having a modulated thickness profile along the propagation direction of the virtual images, and wherein the output-coupling SRG comprises a gradient refractive index profile along the propagation direction of the virtual images.

In another example, the see-through waveguide combiner further includes an input-coupling SRG disposed on the substrate for input-coupling virtual images from the display engine into the see-through waveguide combiner. In another example, the see-through waveguide combiner further includes a redirection SRG disposed on the substrate, the redirection SRG configured for coupling the virtual images between the input-coupling SRG and the output-coupling SRG and further configured for expanding an exit pupil of the virtual images in a first direction, and wherein the output-coupling SRG is configured for expanding the exit pupil in a second direction that is orthogonal to the first direction. In another example, the residual layer comprises two or more inkjet resin films, each resin film having a different refractive index. In another example, the two or more inkjet resin films are layered. In another example, the two or more inkjet resin films are configured in a one-dimensional or two-dimensional patterned array. In another example, the two or more inkjet resin films are at least partially merged. In another example, the modulated thickness profile includes a constant thickness region between approximately 45 to 90 nm of grating structure depth in which the residual layer thickness is approximately 50 nm and a variable thickness region is between approximately 130 to 195 nm of grating structure depth in which the residual layer thickness increases from approximately 30 to 230 nm. In another example, the refractive index profile includes a constant refractive index region between approximately 40 and 100 nm of grating structure depth in which the refractive index is approximately 1.6 and further includes a variable refractive index region between approximately 100 and 130 nm of grating structure depth in which the refractive index of grating structures increases from approximately 1.6 to 1.85.

A further example includes a head-mounted display (HMD) device wearable by a user and supporting a mixed-reality experience including viewing virtual images from a virtual world that are combined with real-world images of objects in a real world, comprising: a display engine configured for producing virtual images; a see-through waveguide combiner through which the user can view the physical world and on which the virtual images are rendered within a field of view (FOV) of the HMD device, the see-through waveguide combiner comprising a substrate; a foundation layer disposed on the substrate, the foundation layer having a first refractive index value; and an output-coupling diffractive optical element (DOE) disposed on the foundation layer, the output-coupling DOE comprising surface relief grating (SRG) structures and a residual layer having a second refractive index value that is different from the first refractive index value.

In another example, the SRG structures have the second refractive index value and in which the first refractive index value of the foundation layer is lower relative to the second refractive index value of the SRG structures and the residual layer. In another example, the SRG structures have the second refractive index value and in which the first refractive index value of the foundation layer is higher relative to the second refractive index value of the SRG structures and the residual layer. In another example, the foundation layer comprises two or more resin sub-layers wherein each resin sub-layer has a different refractive index value than that of an adjacent resin sub-layer. In another example, the foundation layer comprises two resin sub-layers wherein one of the resin sub-layers has the second refractive index value and the other of the resin sub-layers has a third refractive index value that is higher relative to the second refractive index value. In another example, the SRG structures and residual layer have the second refractive index value, the second refractive index value being higher relative to the first refractive index value and further being lower relative to the third refractive index value.

A further example includes a method for fabricating a surface relief grating (SRG) that out-couples virtual images over views, by a user, of a real world, the method comprising: providing a see-through substrate; configuring an inkjet system for forming resin films on the substrate, the inkjet system using two or more different inkjet-printable resins each having a different refractive index; operating the inkjet system to dispense the different inkjet-printable resins in a patterned array on the substrate in resin films; using the dispensed resin films to form a residual layer having a gradient thickness on the substrate; and using the dispensed resin films to create initial diffractive grating structures having a gradient refractive index on the substrate.

In another example, the patterned array is defined by one or more of resin type or droplet size. In another example, the array comprises a one-dimensional array or a two-dimensional array in a plane of the substrate. In another example, the method further comprises using a fabrication process for creating final diffractive grating structures comprising one of photolithography, nanoimprint lithography, electron-beam lithography, or etching. In another example, the inkjet system operating comprises dispensing the different inkjet-printable resins using a wet mixing process.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A see-through waveguide combiner, employable by a user in a mixed-reality display system, the waveguide combiner combining virtual images with views of a real world by the user, comprising:
a transparent substrate propagating virtual images in-coupled from a display engine in total internal reflection along a propagation direction; and
an output-coupling surface relief grating (SRG) disposed on the substrate, the SRG including grating structures having increasing depth along the propagation direction of the virtual images, the output-coupling SRG configured for output-coupling the virtual images from the see-through waveguide combiner to an eye of the user,
wherein the output-coupling SRG comprises a residual layer underneath the grating structures, the residual layer being disposed over the substrate and having a modulated thickness profile along the propagation direction of the virtual images, and
wherein the output-coupling SRG comprises a gradient refractive index profile along the propagation direction of the virtual images.

2. The see-through waveguide combiner of claim 1 further including an input-coupling SRG disposed on the substrate for input-coupling virtual images from the display engine into the see-through waveguide combiner.

3. The see-through waveguide combiner of claim 2 further including a redirection SRG disposed on the substrate, the redirection SRG configured for coupling the virtual images between the input-coupling SRG and the output-coupling SRG and further configured for expanding an exit pupil of the virtual images in a first direction, and wherein the output-coupling SRG is configured for expanding the exit pupil in a second direction that is orthogonal to the first direction.

4. The see-through waveguide combiner of claim 1 in which the residual layer comprises two or more inkjet resin films, each resin film having a different refractive index.

5. The see-through waveguide combiner of claim 4 in which the two or more inkjet resin films are layered.

6. The see-through waveguide combiner of claim 4 in which the two or more inkjet resin films are configured in a one-dimensional or two-dimensional patterned array.

7. The see-through waveguide combiner of claim 4 in which the two or more inkjet resin films are at least partially merged.

8. The see-through waveguide combiner of claim 1 in which the modulated thickness profile includes a constant thickness region between approximately 45 to 90 nm of grating structure depth in which the residual layer thickness is approximately 50 nm and a variable thickness region is between approximately 130 to 195 nm of grating structure depth in which the residual layer thickness increases from approximately 30 to 230 nm.

9. The see-through waveguide combiner of claim 1 in which the refractive index profile includes a constant refractive index region between approximately 40 and 100 nm of grating structure depth in which the refractive index is approximately 1.6 and further includes a variable refractive index region between approximately 100 and 130 nm of grating structure depth in which the refractive index of grating structures increases from approximately 1.6 to 1.85.

10. A head-mounted display (HMD) device wearable by a user and supporting a mixed-reality experience including viewing virtual images from a virtual world that are combined with real-world images of objects in a real world, comprising:
a display engine configured for producing virtual images;
a see-through waveguide combiner through which the user can view the physical world and on which the virtual images are rendered within a field of view (FOV) of the HMD device, the see-through waveguide combiner comprising a substrate;
a foundation layer disposed on the substrate, the foundation layer having a first refractive index value; and
an output-coupling diffractive optical element (DOE) disposed on the foundation layer, the output-coupling DOE comprising surface relief grating (SRG) structures and a residual layer having a second refractive index value that is different from the first refractive index value.

11. The HMD device of claim 10 in which the SRG structures have the second refractive index value and in which the first refractive index value of the foundation layer is lower relative to the second refractive index value of the SRG structures and the residual layer.

12. The HMD device of claim 10 in which the SRG structures have the second refractive index value and in which the first refractive index value of the foundation layer is higher relative to the second refractive index value of the SRG structures and the residual layer.

13. The HMD device of claim 10 in which the foundation layer comprises two or more resin sub-layers wherein each resin sub-layer has a different refractive index value than that of an adjacent resin sub-layer.

14. The HMD device of claim 10 in which the foundation layer comprises two resin sub-layers wherein one of the resin sub-layers has the second refractive index value and the other of the resin sub-layers has a third refractive index value that is higher relative to the second refractive index value.

15. The HMD device of claim 14 in which the SRG structures and residual layer have the second refractive index value, the second refractive index value being higher relative to the first refractive index value and further being lower relative to the third refractive index value.

16. A method for fabricating a surface relief grating (SRG) that out-couples virtual images over views, by a user, of a real world, the method comprising:
providing a see-through substrate;
configuring an inkjet system for forming resin films on the substrate, the inkjet system using two or more different inkjet-printable resins each having a different refractive index;
operating the inkjet system to dispense the different inkjet-printable resins in a patterned array on the substrate in resin films;
using the dispensed resin films to form a residual layer having a gradient thickness on the substrate; and
using the dispensed resin films to create initial diffractive grating structures having a gradient refractive index on the substrate.

17. The method of claim 16 in which the patterned array is defined by one or more of resin type or droplet size.

18. The method of claim 16 in which the array comprises a one-dimensional array or a two-dimensional array in a plane of the substrate.

19. The method of claim 16 further comprising using a fabrication process for creating final diffractive grating structures comprising one of photolithography, nanoimprint lithography, electron-beam lithography, or etching.

20. The method of claim 16 in which the inkjet system operating comprises dispensing the different inkjet-printable resins using a wet mixing process.
